(19) United States
(12) Patent Application Publication
(10) Pub. No.: US 2015/0269607 A1
(43) Pub. Date: Sep. 24, 2015

(54) Generation and Management of a Promotional Campaign

(71) Applicant: Cox Target Media, Inc., Largo, FL (US)

(72) Inventors: Fred Steube, Atlanta, GA (US); Michael Vivio, Atlanta, GA (US); James Christian Cate, Atlanta, GA (US); Nancy Cook, Atlanta, GA (US)

(73) Assignee: Cox Target Media, Inc., Largo, FL (US)

(21) Appl. No.: 14/221,233

(22) Filed: Mar. 20, 2014

(51) Int. Cl. G06Q 30/02

(52) U.S. Cl. CPC G06Q 30/0244; G06Q 30/0276; G06Q 30/0207

(57) ABSTRACT

Aspects of the disclosure include generation and management of promotional campaigns that can provide a satisfactory performance for a specific amount of resources allocated to the campaigns. In one aspect, at least one of the promotional campaigns can be distributed via media channels that pertain to an organization that administers the promotional campaigns and/or media channels associated with a third-party partner (e.g., a syndication or reseller partner) of such an organization. In another aspect, a promotional campaign can be developed for a predetermined resource allocation, where the promotional campaign can include satisfactory offers that can reach a satisfactory audience at an adequate time via an adequate distribution channel. In order to attain an adequate level of transactions, the promotional campaign can be dynamically restructured based on performance of the campaign across distribution channels available for the predetermined resource allocation.

### BACKGROUND

A promotional campaign generally is merchant specific and is distributed via specific media channel(s) based on the scope of the scope of the campaign, which in turn, typically is determined by resource constraints, such as campaign budget, desired or otherwise intended media channel(s) for distribution, target audience, or the like. Efficacy of the promotional campaign can depend largely on adequate promotional content and/or adequate selection of media channel(s) that can generate impressions that are relevant and well received by an audience. Usually the selection of promotional content and/or a media channel for distribution of promotional campaigns can be outside of the expertise of the merchant, with the ensuing implementation of a likely underperforming campaign. Even for a satisfactory promotional campaign, management of the campaign itself can be result in an onerous expenditure of both human and monetary resources that may be outside the resource constraints of the merchant.

### BRIEF DESCRIPTION OF THE DRAWINGS

The accompanying drawings are an integral part of the disclosure and are incorporated into the present specification. The drawings illustrate examples of embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as being limited to the implementations set forth herein. Like numbers refer to like, but not necessarily the same, elements throughout.

FIG. 1 illustrates an example of configuration of a promotional campaign in accordance with at least certain aspects of the disclosure.

FIG. 2 presents an example of an operational environment in accordance with at least certain aspects of the disclosure.

FIGS. 3A-3C present, respectively, examples of composition of promotional content and/or promotional products and example allocation to illustrative distributions channels in accordance with at least certain aspects of the disclosure.

FIG. 4 presents another example operational environment in accordance with at least certain aspects of the disclosure.

FIG. 5 presents an example of a computational environment in which at least certain functionality may be implemented in accordance with at least certain aspects of the disclosure.

FIG. 6 presents an example of a method in accordance with at least certain aspects of the disclosure.

### DETAILED DESCRIPTION

The disclosure recognizes and addresses, in at least certain aspects, the issue of distribution of promotional campaigns that drive transactions across distribution channels. The disclosure provides devices, systems, techniques, and/or computer program products for generation and management of promotional campaigns that can provide a satisfactory performance (e.g., optimal or nearly optimal performance) for a specific amount of resources (monetary or non-monetary) allocated to the campaigns. One or more of the promotional campaigns can be distributed via media channels that pertain to an organization that administers the promotional campaigns and/or media channels associated with a third-party partner (e.g., a syndication or reseller partner) of such an organization. As described in greater detail below, in one aspect, the disclosure can permit development of a promotional campaign for a predetermined resource allocation (e.g., budget for advertisement). In one example, the promotional campaign can include satisfactory offers that reach a satisfactory audience at an adequate time via an adequate distribution channel. It should be appreciated that, for example, such a distribution channel can pertain to an agent that develops the promotional campaign, or to commercial or otherwise business partner of the agent. In an additional or alternative aspect, the disclosure can dynamically restructure (e.g., dynamically scale) the distribution of the promotional campaign in order to attain a satisfactory level of transactions across distribution channels that are available for the predetermined resource allocation. Offers can include incentives, such as rewards (monetary or non-monetary), coupons, deals, discounts, and/or savings offers of various types for a category of merchandise and/or services. A satisfactory offer can be embodied in a best offer, a second-best offer, or the like, and a satisfactory audience can include most consumers in a population, a segment of consumers in the population, most prospective consumers in the population, a segment of prospective consumers in the population, a combination thereof, or the like. Adequacy of a time for providing an impression of an offer and adequacy of a media channel for distribution of the offer can be assessed or otherwise measured by determining a response of an audience to the offer. Such a response can be a realtime or nearly realtime response, or can include historical response(s) (such as a stated or observed preference for certain offers, prior transactions associated with an offer, social signals or other behavior within a social network (either a first-life network or a second-life (or virtual life) network in response to an offer, combinations thereof, or the like). Responsiveness of the audience to an offer can be represented or otherwise characterized by a metric indicative or otherwise representative of interaction with the offer by the audience or a member thereof. The interaction can include redemption of the offer and/or other action effected by the audience, or a member thereof, in response to the offer (e.g., calling a specific device specified in the offer, sharing the offer, filling out forms included or associated with the offer, combinations thereof, or the like) and/or other interactions with the offer.

Aspects, features, and/or advantages of the disclosure can be applied to most any organization that provides a service and/or product. In particular, yet not exclusively, small and/or medium businesses can benefit or otherwise leverage various aspects of the disclosure to address issues such as generation of satisfactory offers (e.g., optimal or nearly-optimal offers), and distribution and management thereof on various media channels, such as Google, Facebook, Bing, or other platforms. A small or medium business having any geographic footprint (e.g., one or more business locations, such as stores, fitness facilities, warehouse facilities, and the like) can leverage the rich, historical and contemporaneous information resources disclosed herein. As such, in one aspect, the small or medium business can formulate or otherwise have access to a promotional campaign as if such a business were a much larger organization. In accordance with the disclosure, as an illustration, an organization can pertain to an industry vertical that can be embodied in or can comprise (i) agriculture; (ii) education and childcare; (iii) insurance services; (iv) Internet and online market; (v) not-for-profit; (vi) retail and consumer services; (vii) utilities; (viii) banking and financial services; (ix) hospitality and travel services; (x) legal services; (xi) law enforcement; (xii) media and entertainment; (xiii) real estate and property; (xiv) transportation and logistics; (xv) construction; (xvi) energy and environment; (xvii) healthcare and pharmaceuticals; (xviii) manufacturing and engineering; (xix) public sector; (xx) gastronomy services; (xxi) small businesses; (xxii) consumer electronics; (xxiii) consumer goods; (xxiv) food and dining; (xxv) consumer product goods; (xxvi) home improvement; combinations thereof; or the like. In addition, small business entities or medium business entities also can be organized in business verticals or segments, such as auto dealer; auto repair or workshop; general contractor; landscaping and land management; customer loyalty; consumer goods distribution; good distribution; franchise management; funeral industry; home services, jewelry store management; pharmacy; photographic studios; salons; service dispatch; restaurants; personal services; office services; small office; and the like.

Embodiments of the disclosure can provide various advantages over conventional technologies for management of promotional campaigns. One example advantage may include identification of promotional products (e.g., a reward, a coupon, a deal, a discount, or the like) that can be based at least on temporal, spatial, and/or contextual information associated with an intended recipient of the promotional products. Another example advantage may include dynamic restructuring (also referred to as dynamic shaping) of a promotional campaign based on performance of, or responsiveness of an audience to, the promotional campaign and within a specific resource constraint associated with the campaign. Since information indicative of performance of, or responsiveness to, a promotional campaign can be accessed or otherwise acquired (e.g., collected or otherwise received) automatically as opposed to manually, at least a portion of such information can be accessed in time scales having disparate resolutions spanning various orders of magnitude, including realtime or nearly realtime. Accordingly, in at least certain implementations, the promotional campaign can be shaped or otherwise restructured nearly continuously or within periods having most any time scale (e.g., milliseconds, seconds, minutes, hours, days, weeks, and the like). Such a restructuring of a promotional campaign can permit customization and/or optimization thereof based on a rich, massive pool of actual promotional information (e.g., deal data, deal metadata, a combination thereof, or the like) that can exceed the promotional information germane to the an organization (e.g., a business, a non-profit organization, and the like). In addition, acquisition (e.g., measurement) of information indicative or otherwise representative of performance of a promotional campaign can permit generating (dynamically or otherwise) business intelligence that can be recursively refined (e.g., improved or augmented), permitting an increasingly accurate identification of an offer category that works satisfactorily (e.g., best, second best, . . .) over a certain distribution channel, on a particular day and time, in a specific location, and so forth. Yet another example advantage may include increased efficacy of a promotional campaigns over time, with the ensuing increased efficiency of utilization of resources (monetary or otherwise) available for promotional campaigns.

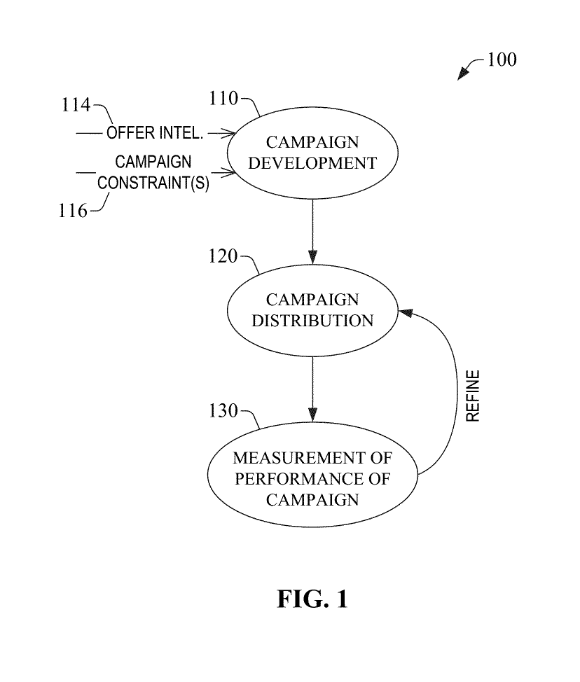

With reference to the drawings, FIG. 1 presents an example of a configuration scheme 100 for a promotional campaign in accordance with at least certain aspects of the disclosure. Configuration can include generation and management of the promotional campaign and, as illustrated, it can include several stages constituting generation and management of the promotional campaign. As illustrated, the stages can include a campaign development stage, a campaign distribution stage, and a performance measurement stage, which are represented, respectively, by blocks 110, 120, and 130. At the campaign development stage (block 110), promotional content for an organization (e.g., a merchant) can be generated. Generation of promotional content and/or promotional products can include acquisition of offer intelligence 114 indicative or otherwise representative of content, format, design, type, and/or performance of offers for organizations. In one aspect, the offer intelligence 114 (which also may referred to as promotional intelligence 114) can include knowledge associated with a suitable offer type—e.g., an offer type that provides a satisfactory level of responsiveness from an audience—having a format and content pertinent to a product or service category for an organization at a specific time. (e.g., season, month, week, day, time of day, location, a combination thereof, or the like). Such knowledge can include concepts, empirical observations, or the like, that can permit identification of a promotional product (e.g., such as an offer, a reward, a coupon, a deal, a discount, or the like) that can be based at least on temporal information (contemporaneous and/or historical), spatial information, and/or contextual information associated with at least a portion of the audience intended for the promotional product. The contextual information can include one or more of local and/or macro environmental information associated with the audience (e.g., local weather conditions, festive events, community events, civic events, holidays, and the like, in a location of the audience or a member thereof); business information associated with an organization related to the promotional product; demographic and/or psychographic information indicative or otherwise representative of audience segments or profiles (e.g., urban male in his forties; divorced male in his forties; and the like) having a specific likelihood of responding to the promotional product; combinations thereof; and the like. For instance, in an example scenario in which the organization is a pizzeria, at least a portion of the offer intelligence 114 can convey that a buy-one-get-one (BOGO) medium pepperoni pizza outperforms a mushroom pizza offer of a different type (e.g., a discount on price point), by seasonality, location, and category performance.

In certain implementations, the offer intelligence 114 can contain information from a plurality of sources of offer intelligence (which may be referred to as “offer intelligence sources”), where at least one (e.g., one, two, more than two, each) of such sources can provide intelligence associated with a respective facet of promotional content. For example, at least one of the plurality of offer intelligence sources can include catalog information indicative or otherwise representative of contemporaneous and historical promotional campaigns and related offers for a group of organizations spanning a predetermined period (e.g., minutes, days, weeks, 1, 2, 3, 4, 5, 10, 15, 20, 25, 30, 35, or 40 years). The predetermined period can be determined at least by the type of promotional campaign (e.g., direct-mail campaigns, web-based campaigns, etc.), industry vertical, a combination thereof, or the like. For another example, at least one source of the plurality of offer intelligence sources can include format information (e.g., data and/or metadata) indicative of promotional content associated with contemporaneous and/or historical offers. The promotional content for a respective offer can include the offer itself (e.g., a discount, a free-of-charge indication, a BOGO indication, a combination thereof, or the like); a headline associated with the respective offer; information representative of the offer and/or an organization associated with the offer; and/or other information associated with the respective offer. For yet another example, at least one source of the plurality of offer intelligence sources can include knowledge indicative of advisable practices (e.g., best practices) for issuance of specific offers (e.g., coupons, rewards, and/or other incentives) according to season (or other instants, such as day, week, month, or the like); location; target market (e.g., intended consumer audience) segmentation; product category; service category; and/or organization category. For a further example, at least one source of the plurality of offer intelligence sources can include intelligence that can convey satisfactory content (e.g., best content, second-best content, multiple offers, or the like) for promotional content and/or satisfactory type (e.g., best type, second-best type, or the like) of promotional content, such as a percentage discount over price point, an absolute discount (e.g., a specific dollar amount) over price point, BOGO offer, qualified free-of-charge offer, combination thereof, or the like.

In certain embodiments, one or more sources of offer intelligence can be embodied or can include at least one information structure (e.g., a database, either relational or non-relational) of temporal, spatial, contextual, and/or environmental information indicative or otherwise representative of intelligence associated with promotional content and/or promotional products. In one example, the at least one information structure can include a numerous records generated or otherwise acquired over a multi-year period in accordance with one or more time scales (e.g., sub-millisecond, second, minutes, hours, days, weeks, months, or years). In another example, records within the at least one information structure can be organized or otherwise arranged according to relevance to a specific type of merchant or, more generally, organization (e.g., small business, medium business, etc.).

In addition or in the alternative, the campaign development stage can implement or otherwise utilize information (e.g., data and/or metadata) indicative or otherwise representative of expected performance of a promotional campaign based at least on one or more campaign constraints 116, such as available budget; running period; desired market; preferred distribution channels; campaign goals; a combination thereof; or the like. In one example, a campaign goal can include increasing profit margin, increasing revenue, increasing redemption rate, increasing profitability, increasing number of customers, a combination thereof, or the like. In one example implementation of the campaign development stage, the offer intelligence can support the expected performance a promotional campaign that may be recommended based at least on a portion of the campaign constraint(s) 116. Stated differently, offer intelligence 114 can permit evaluating a recommended promotional campaign in light of at least one of the known campaign constraint(s) 116, where such an evaluation may confirm that the recommended promotional campaign conforms or substantially conforms to the at least one campaign goal. In one example, the offer intelligence also can permit assessing expected profitability or return on investment of the promotional campaign. More specifically, one of the recommended promotional marketing channels (which also may be referred to as distribution channels) in the campaign may cause more people to visit merchant's establishment, but may cost more than a second campaign, which therefore may provide a higher return on investment.

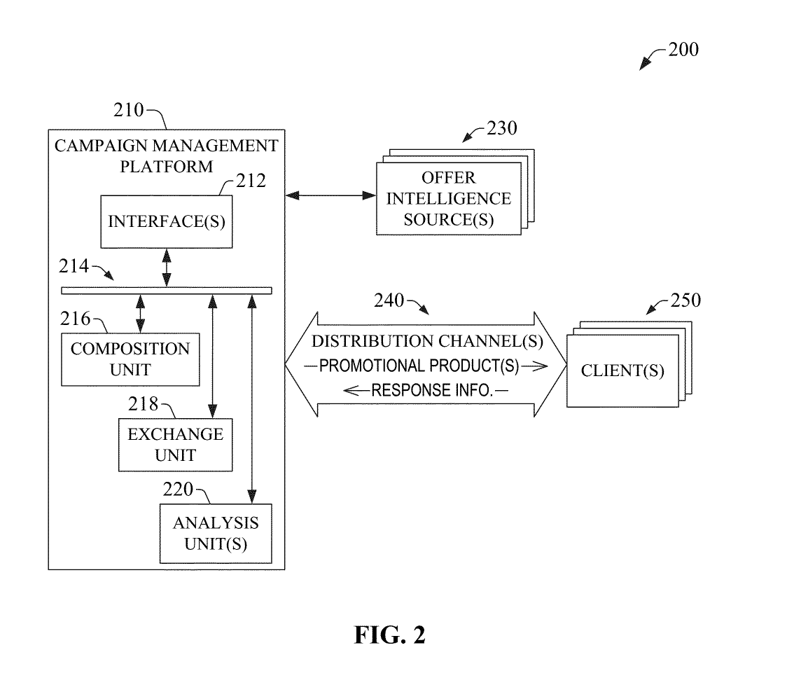

In certain implementations, such as in the illustrative operational environment 200 presented in FIG. 2, a group of offer intelligence sources 230 (referred to as offer intelligence source(s) 230) can supply at least a portion of the offer intelligence 114 to a campaign management platform 210 that implement the campaign development stage. To at least such an end, in one aspect, a source of the offer intelligence source(s) 230 can expose and/or communicate data, metadata, and/or signaling via an interface in response to a query (e.g., a request for data, a search query) or a directive from the campaign management platform 210. The offer intelligence source(s) 230 can include information structures (e.g., datasets, databases, and the like) indicative or otherwise representative of intelligence and/or knowledge associated with offers (e.g., coupon or other incentives) and/or management and distribution of promotional content (e.g., advertisement). Such information structures can include information that is time-dependent, including records of information at various instants (e.g., a data, a time of day, a time of week, a time of month, or the like), which can be historical instants or forecasted instants over a certain period. In addition, the at least a portion of the information structures can include contextual information, environmental information, demographic and/or psychographic information, combinations thereof, and the like.

The information structure(s) contained in an offer intelligence source of the source(s) 230 can be generated or otherwise composed as a function of time via one or more feedback mechanisms (automated, non-automated, or both). More particularly, in one example, the information structures contained in the offer intelligence source(s) 230 may have been generated via collection, over a period of time (e.g., years), of one or more of the following: (1) information indicative of best practices in design and/or offer construction; (B) information indicative of merchant redemption performance via analog and/or digital mechanisms (e.g., webpage traffic measurements, form filling information, email and mobile communication responses, social shares or redistribution of offers, consumer survey and interview feedback, eye-tracking, readership studies, combinations thereof, or the like); (C) information indicative of monitored or tracked call sessions (e.g., voice calls and/or data calls) associated with responsiveness by an audience to an offer or a promotional product; (D) combinations of these information, and the like. It should be appreciated that such information collection can be implemented with human intervention or in automated fashion, or both. Analysis of the historical and/or contemporaneous collected information can permit extracting knowledge that can represent the offer intelligence (or promotional intelligence) contained in the information structures available in the offer intelligence source(s) 230.

The collection of information that permits generation or composition of the offer intelligence contained in an offer intelligence source can be performed by an agent (human or non-human) that is either internal to an operator platform that administer the campaign management platform 210 or external to the operator platform. In one aspect, an external agent (e.g., a computing system external to such operator platform) can inspect web-based resources (e.g., databases, server farms, and the like) or portions of the Internet via a web crawler component, or can inspect connected networks and/or cloud-based resources in order to extract information associated with offer information distributed over such networked environments and/or merchant redemption performance reporting (e.g., call tracking, web page traffic measurement, form filling, email and mobile responses, social shares, consumer survey and interview feedback, eye-tracking, readership studies, combinations thereof, or the like).

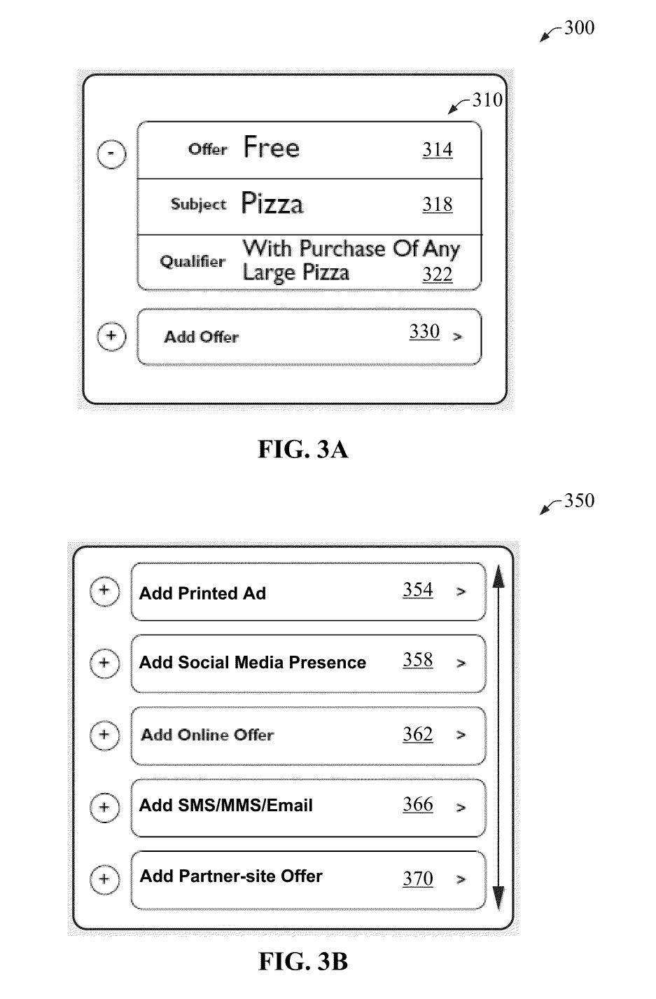

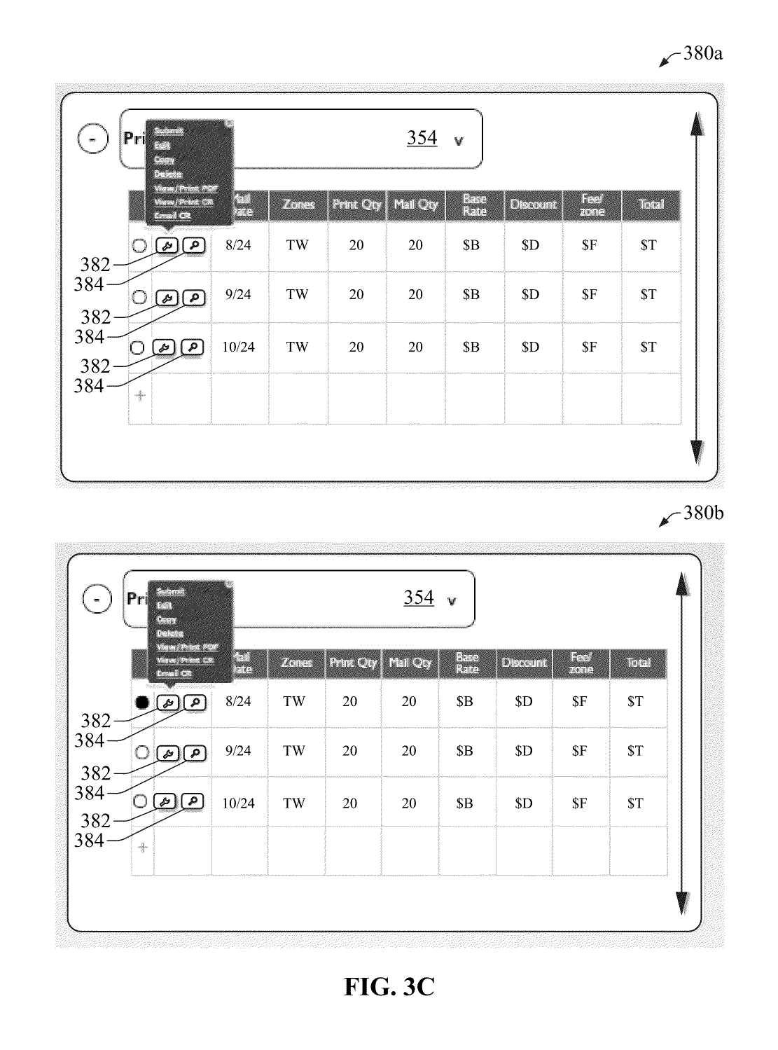

The campaign management platform 210 can receive the offer intelligence 114 via at least one interface of a group of one or more interfaces 212 (also referred to as interface(s) 212). In addition, the campaign management platform 210 can include a composition unit 216 that can generate promotional content and/or promotional product(s) based at least on a portion of the offer intelligence 114. In a scenario in which the offer intelligence 114 contains information indicative of a historical promotional product, the composition unit 216 can access such information and can determine or extract promotional content (e.g., an offer) from such information. The promotional product can include, for example, a promotional product that has been published either by an operator of the campaign management platform 210 or by a commercial partner and/or competitor agent. In addition, in a scenario in which historical products are unavailable (e.g., previously unpublished), the composition unit 216 can access (e.g., collect or otherwise receive) information indicative or otherwise representative of an offer. The composition unit 216 can record (e.g., retain in memory) such information and can generate a logical record of the offer, and thus can create the offer. The composition unit 216 can create a set of one or more offers, without restriction on the cardinality of such a set, which can span various goods, products, and/or services. The composition unit 216 also can assign an offer of the set of one or more offers to a specific media channel, promotional product, and/or a platform for publication. In one implementation, the composition unit 216 can utilize or otherwise leverage an interface of the interface(s) 212 in order to access at least a portion of the selection information. In certain embodiments, the interface can include a graphical user interface (GUI) and the composition unit 216 can direct or otherwise cause a display device, which can be contained in the interface(s) 212, to render the GUI for collection or otherwise reception of the information indicative or representative of the offer. As an illustration, FIG. 3A presents an example of a GUI 300 that can permit supplying information indicative of an offer. As illustrated, the GUI 300 can include indicia 310 that can permit specifying the offer. The indicia 310 can include a field 314 to define an incentive (which also may be referred to as the offer itself), a field 318 to define a subject (e.g., a specific good or service) associated with the offer, and a field 322 to define a qualifier for the offer's incentive. In addition, the GUI 300 also can include indicia 330 that, in response to actuation (e.g., interaction with the indicia via selection, touch, or gesture), can permit collection of information indicative or otherwise representative of another offer.

As described herein, the offer intelligence 114 can include content, such as logos, images, marketing messages, offer terms, expiration dates, menus, video segments, audio segments, images, multimedia assets or other rich media assets, or the like, that can be incorporated into an offer in order to generate a promotional product—e.g., an offer and advertisement. At least a portion of such content can be exposed or otherwise provided via at least one interface of the interface(s) 212. In one implementation, the at least one interface can include a graphical user interface (GUI) and the composition unit 216 can direct or otherwise cause a display device, which can be contained in the interface(s) 212, to render the GUI for presentation (e.g., via a pull-down menu or other indicia) of the content. In addition or in the alternative, the GUI can permit collection or otherwise reception of selection information indicative or representative of selected content from the content that is presented. The composition unit 216 can access at least a portion of the selection information and can combine an offer with selected content. Accordingly, in one aspect, the composition unit 216 can generate promotional content via such a combination.

The composition unit 216 can generate a promotional product for a promotional campaign for an organization—e.g., a small or medium business, such as family-operated restaurant or a franchisee, a bakery, or the like. The promotional product can include promotional content (e.g., an offer and content, such as advertisement), and can be characterized by one or more of product type, period for distribution (which may be informally referred to as “run dates”), product cost, distribution channel or medium, or the like. In addition, the promotional product can be generated based at least on an amount of resources (e.g., a budget or other monetary resource) and/or campaign timing available to the organization for the promotional campaign and/or a category of the organization. In certain implementations, such a category can be represented by the North American Industry Classification System (NAICS) code and/or size of the organization. In addition or in the alternative, proprietary information indicative or representative of the organization also can be utilized or otherwise leveraged to convey the category of the organization. In one aspect, the amount of resources, time, location, campaign goal, preferred or available distribution channel, external campaign efforts, complexity of or familiarity with the distribution channel, and/or the category of the organization can determine or otherwise dictate a quantity of promotional products that the composition unit 216 can generate. As resource constraints are eased (e.g., budget for a promotional campaign is increased), the scope of promotional products generated by the campaign management platform 210 can increase and/or distribution channels of more complexity can be leveraged.

At least to generate promotional products, in one aspect, the composition unit 216 can access composition information indicative or otherwise representative of one or more of campaign resources, promotional content, product type, product quantity, period for distribution, distribution channel or medium, or the like. The composition information can define or otherwise characterize a promotional product. In certain implementations, to access the composition information, the composition unit 216 can utilize or otherwise leverage an interface of the interface(s) 212 in order to access at least a portion of the selection information. In certain embodiments, the interface can include a graphical user interface (GUI) and the composition unit 216 can direct or otherwise cause a display device, which can be contained in the interface(s) 212, to render the GUI for collection or otherwise reception of the composition information. As an illustration, FIG. 3B presents an example of a GUI 350 that can permit supplying composition information associated with a promotional product. In one example, a double-headed arrow represents that the contents in the GUI 350 can be scrolled up and/or down. The GUI 350 can include indicia 354-370 that can permit management of respective promotional products, e.g., addition, editing, and/or removal of a promotional product to a specific distribution channel (e.g., printed advertisement, social media presence, online offer, SMS/MMS/email, partner-site, and the like). In one aspect, in response to actuation (e.g., interaction with the indicia via selection, touch, or gesture), such indicia can cause, via the composition unit 216 for example, other graphical interfaces to be rendered in order to supply composition information. Each of the indicia 354, 358, 362, 366, and 370 can permit an operator to access a GUI in which offers or other campaign products can be added, edited, and/or removed from a pool of available offers or campaign products. In one aspect, an offer or campaign product that is selected or otherwise specified or promotional campaign can associated with (e.g., represented by) a line item including product type, quantities, distribution, run dates, costs, and the like, associated with a recommended promotional campaign. In one example, actuation of the indicia 370 can permit addition of offers associated with a business partner of the operator of the campaign management platform 210. In another example, actuation of indicia 370 also can permit syndication of offers to third-party platforms (e.g., a business partner).

FIG. 3C presents examples of graphical interfaces (which can be contained with the interface(s) 212) that can be provided (e.g., rendered) in response to actuation of indicia 354 (“Add Print Add”). As illustrated in diagram 380a, each line item can acquire order information (such as start/end dates, distribution, pricing, and the like). Each line item also can have a task icon 382 and a search icon 384. In one example, in response to actuation, the task icon 382 can permit an operator to manipulate the product associated with the actuated icon. For example, the operator can edit text and/or images for the product. Other operations can include “submit” a line item, “edit,” “copy,” delete,” “view/print” in different formats, and “email” or communicate according to other mechanisms. More particularly, selecting the task icon 382 and then “change text/images” can cause a standard “change/text images” overlay form, or other type of interface, to be rendered for the product. In one aspect, the “change text/images” form can be pre-populated with promotional content that was previously confirmed and/or selected based on a search of content resources (which can be contained in the offer intelligence source(s) 230. The operator can edit, save, and/or cancel the content with standard features (e.g., suggested content, stock images, uploads, etc.). Further, as illustrated in diagram 380b, each line item can be selected or deselected (e.g., checked on or off) to become part of a promotional campaign. In one example, respective double-headed arrows in diagrams 380a and 380b represent that the contents illustrated in the diagram can be scrolled up and/or down.

As illustrated in FIG. 1, in response to (e.g., upon or after) development of a promotional campaign for an organization, which as described herein, includes generation of promotional content and promotional products, a campaign distribution stage (block 120) can be implemented. Such a stage can include distribution of promotional products associated with the promotional campaign via media channels that pertain to an administrator organization that administers the promotional campaigns (which may be referred to as intrinsic channels) and/or media channels associated with a third-party partner of such an organization (which may be referred to as third-party channels). It can be appreciated that, in one aspect, the promotional products that are distributed can be allocated or otherwise assigned to a distribution channel in accordance with the predetermined resources available for the promotional campaign, such as a predetermined monthly budget for advertisement expenditure, e.g., $800 per month. As described herein, the promotional campaign and the distribution thereof can target recipients (e.g., consumers or prospective consumers) that may satisfy one or more organization's performance objectives (such as acquisition of customers, retention of customers, reengagement of customers, combination thereof, or the like); and/or can drive transactions between the consumers and the organization.

In an example implementation of the campaign distribution stage (block 120), such as in the illustrative operational environment 200 presented in FIG. 2, an exchange unit 216 can communicate information indicative or otherwise representative of promotional product(s) via one or more distribution channels 240 (referred to as distribution channel(s) 240). Communication of the promotional product(s) can be referred to as distribution of the promotional campaign. As described herein, at least one of the distribution channel(s) 240 can communicate the information via a medium that includes non-electronic transport of information (e.g., postal delivery, such as direct mail, or peer-to-peer distribution). More specifically, yet not exclusively, at least a portion of the promotional product(s) (e.g., offers, such as coupons or other incentives) can be delivered in printed media via non-electronic mail or other non-electronic delivery mechanism to a group of recipients. In addition or in the alternative, at least another portion of the promotional product(s) can be communicated, via at least one of the distribution channel(s) 240, to one or more client devices 250 (referred to as client(s) 250). To at least such an end, in certain embodiments, the exchange unit 216 can utilize or otherwise leverage at least one of the interface(s) 212 to communicate a promotional product to a client of the client(s) 250. The interface(s) 212 can be embodied in or can include display device(s); application programming interface(s) (API(s)); graphical user interface(s); information storage (e.g., a database) or a reference thereto (e.g., a link to a database); combinations thereof; or the like. The client(s) 250 can be associated with consumers, prospective consumers, advertisers, and/or other business partners of an operator of the campaign management platform 210. In one example, the client(s) 250 can include computing devices having similar or different functionalities and levels of complexity. The computing devices can include desktop computers; mobile computers (e.g., laptop computers, tablet computers, smartphones or other mobile telephones, or the like); point-of-sale computers; magnetic-card reader devices; optical reader devices; near-field communication (NFC) devices; gaming consoles; gesture-recognition devices and/or interfaces; wearable computing devices; advertising kiosks or display devices; two or more connected human-machine surface interfaces (e.g., devices that permit human-machine interaction via a surface); or the like.

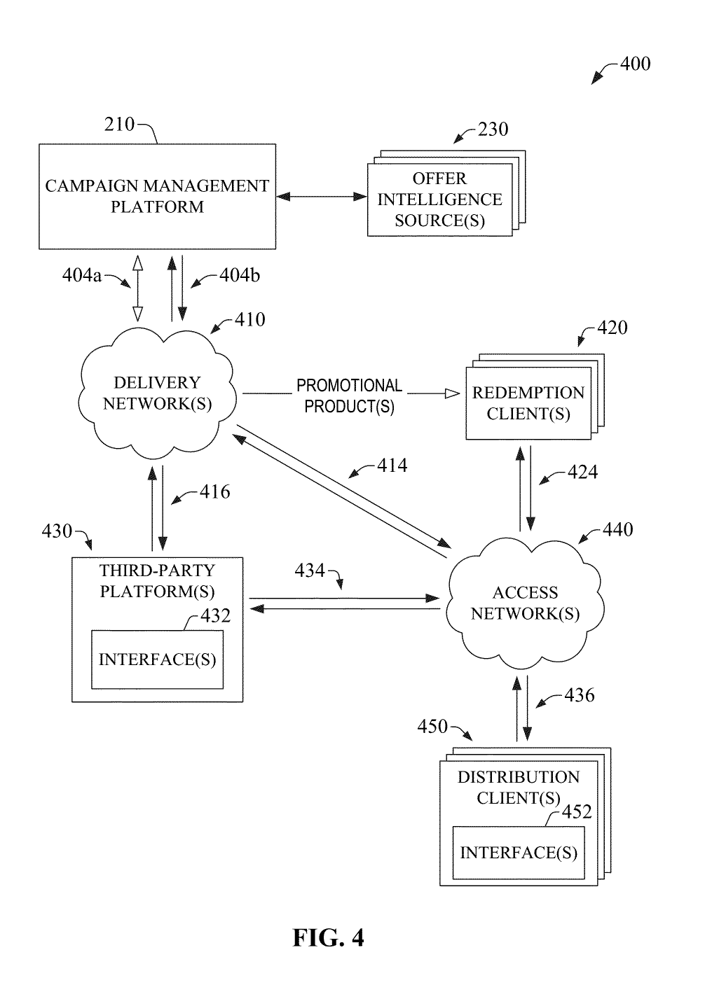

Each of the distribution channel(s) 240 has specific architecture suitable for distribution of the promotional product(s) associated with a promotional campaign for an organization (e.g., a merchant or a service provider). In certain embodiments, such as in operational environment 400 presented in FIG. 4, the distribution channel(s) 240 can include one or more distribution networks 410 (referred to as delivery network(s) 410) coupled (e.g., communicatively coupled or otherwise functionally coupled) to the campaign management platform 210. The functional coupling can be specific to the delivery network that is coupled to the campaign management platform 210. In one aspect, for a distribution channel that utilizes or otherwise leverages printed media (e.g., a circular delivered by a newspaper company), the delivery network associated with such a distribution channel can include a postal delivery network having one or more mail ingestion nodes (e.g., mailrooms, postal offices, or the like) and carriers (e.g., transport vehicles). The postal delivery network can be contained within the delivery network(s) 410, and an ingestion node associated with the campaign management platform 210 and/or a route from such an ingestion node to a third-party ingestion node (e.g., UPS center, FedEx center, or USPS postal office) can constitute the functional coupling between the postal delivery network and the campaign management platform 210. Such a coupling can be represented by the arrow 404a. Promotional product(s) (e.g., a coupon(s)) delivered via the postal delivery network can be transported to one or more redemption clients 420, which can be coupled to one or more access networks 440 via links(s) 424 (e.g., wireless link(s), wireline link(s), reference link(s), middleware, API(s), combinations thereof, or the like). The redemption client(s) can embody or can constitute at least a portion of the client(s) 250.

In scenarios in which promotional products are distributed in electronic format (e.g., a digital media), at least one of the delivery network(s) 410 can be coupled to the campaign management platform 210 via links 404b (e.g., wireless link(s), wireline link(s), reference link(s), combination thereof, or the like), and to one or more access network(s) 440 via links 414 (e.g., wireless link(s), wireline link(s), reference link(s), combination thereof, or the like). In addition or in the alternative, at least one of the delivery network(s) 410 can be coupled to the campaign management platform 210 via links 404b, and to one or more third-party platforms 430 via links 416 (e.g., wireless link(s), wireline link(s), reference link(s), middleware, API(s), combinations thereof, or the like). At least one of the third-party platform(s) 430 can be coupled to one or more of the access network(s) 440 via links 434 (e.g., wireless link(s), wireline link(s), reference link(s), middleware, API(s), combinations thereof, or the like). As illustrated, one or more of the access network(s) 440 can be coupled to one or more distribution clients 450, which can embody or can constitute at least a portion of the client(s) 250 shown in FIG. 2 and described herein.

As illustrated in FIG. 1, in response to distribution of a promotional campaign, which as described herein, includes distribution of promotional products via a group of distribution channels in accordance with a specific distribution allocation, a measurement stage (block 130) can be implemented. The measurement stage can probe or otherwise determine the performance of the promotional campaign based at least on response of an audience to promotional products contained in the promotional campaign. Metrics indicative of audience activity in response to a promotional product can assess or otherwise characterize such a response. The audience activity can include one or more of acquisition of an offer associated with the promotional product (e.g., click on, reproduction, storage, viewing, sharing, saving, or scanning of a coupon or other incentive); redistribution of the promotional product (e.g., publication to peers in social media, such as followers on Twitter, or friends on Facebook; email communications; short message service (SMS) messages; multi-media service (MMS) messages; a combination thereof; or the like); redemption of the offer; initiation of a call session (voice session, data session, or a combination thereof) with an organization or party associated with the promotional product, such as concierge or customer service representative; completion of a survey or other market research instrument; a combination thereof; or the like. Such metrics can be determined for at least one of the distribution channels, e.g., an intrinsic channel and/or a third-party channel, through which the promotional product is distributed.

In an example implementation of the measurement stage (block 130), such as in the illustrative operational environment 200, an analysis unit 220 can determine performance of a promotional campaign. To at least such an end, in one aspect, the analysis unit can determine metrics indicative or otherwise representative of audience activity in response to promotional products distributed via a distribution channel. The analysis unit 220 can access performance information representative of the audience communicate and based on at least a portion of such information, can determine a metric indicative or otherwise representative of audience activity in response to a promotional product. The analysis unit 220 can access (e.g., collect or otherwise receive) at least a portion of the performance information via one or more of the interface(s) 212. In certain embodiments, such as in operational environment 400, a distribution client of the distribution client(s) 450 can provide performance information indicative or otherwise representative of audience activity in response to a promotional product distributed at the distribution client—e.g., rendered, served, or otherwise impressed at an interface associated with the distribution channel. The distribution client can utilize or otherwise leverage a second interface, such an API, associated with (e.g., integrated into or coupled to) the distribution client to access at least a portion of the performance information, and can communicate (e.g., transmit or push) such information to at least one of the interface(s) 432, which can include one or more APIs. A third-party platform or unit associated therewith can relay at least the portion of the performance information to the one or more of the interface(s) 212 that can provide such information to analysis unit 220. Similarly, a redemption client of the redemption client(s) 420 can supply (e.g., transmit or push) performance information representative of redemption of offer(s) (e.g., coupon(s) or other incentive(s)) at the redemption client to the one or more of the interface(s) 212 that can provide such information to analysis unit 220. In addition or in the alternative to acquisition or otherwise collection of performance information, demographic and/or ancillary information (such as who is redeeming an offer and/or other products/services being transacted in conjunction with or in lieu of redeeming the offer.

Measurement of the performance of a promotional campaign can permit assessment of a current distribution allocation of promotional products across different distribution channels; e.g., printed media; aural media (such as radio advertisement, or a voice search); web-based media (including mobile web); mobile application; time-based or otherwise scheduled messages; pushed messages; geolocation-based or geolocation-triggered messages; and the like. Based at least on such an assessment, the current distribution allocation can be refined, and thus, an updated distribution allocation can be generated. The updated distribution allocation can be implemented via the campaign distribution stage (block 120). Generation of updated distribution allocations of promotional products across distribution channels can permit adjustment (e.g., optimization) of a current promotional campaign in response to audience activity (which can be a representation of efficacy of the promotional campaign). It should be appreciated that such an adjustment can be effected consistently with a predetermined amount of resources (e.g., advertisement budget) for the promotional campaign. Such an adjustment can permit reallocation of the distribution of promotional products towards a group of distribution channels that present a satisfactory level (e.g., highest level) of audience activity.

Performance information associated with a promotional campaign can be utilized or otherwise leveraged to generate offer intelligence, which can be utilized by the campaign management platform 210 to update and/or augment at least one of the offer intelligence source(s) 230 and/or the promotional campaign. In certain embodiments, the analysis unit 220 can include a learning engine that can generate information, intelligence, and/or knowledge associated with promotional campaigns via various machine-learning techniques (e.g., classification, regression, clustering, ensemble learning, Bayesian inferences, combinations thereof, and so forth). Accordingly, it can be readily appreciated that, in one aspect, promotional campaigns generated in accordance with aspects of the disclosure can have higher efficacy over time, with the ensuing increased efficiency of utilization of resources (monetary or otherwise) available for promotional campaigns.

In connection with the campaign management platform 210, it should be appreciated that although the interface(s) 212, the composition unit 216, the exchange unit 218, and the analysis unit 220 are illustrated as separate functional elements, embodiments in which two or more of such elements are integrated or otherwise combined also are contemplated in the disclosure. In addition, it should be appreciated that two or more of the functional elements (e.g., units, interfaces, and the like) can exchange information via a communication platform 214 (e.g., wireless links, wireline links, reference links, middleware, bus architectures, combinations thereof, or the like). Similarly, in certain embodiments, one or more of the offer intelligence source(s) 230 can form part of the campaign management platform 210.

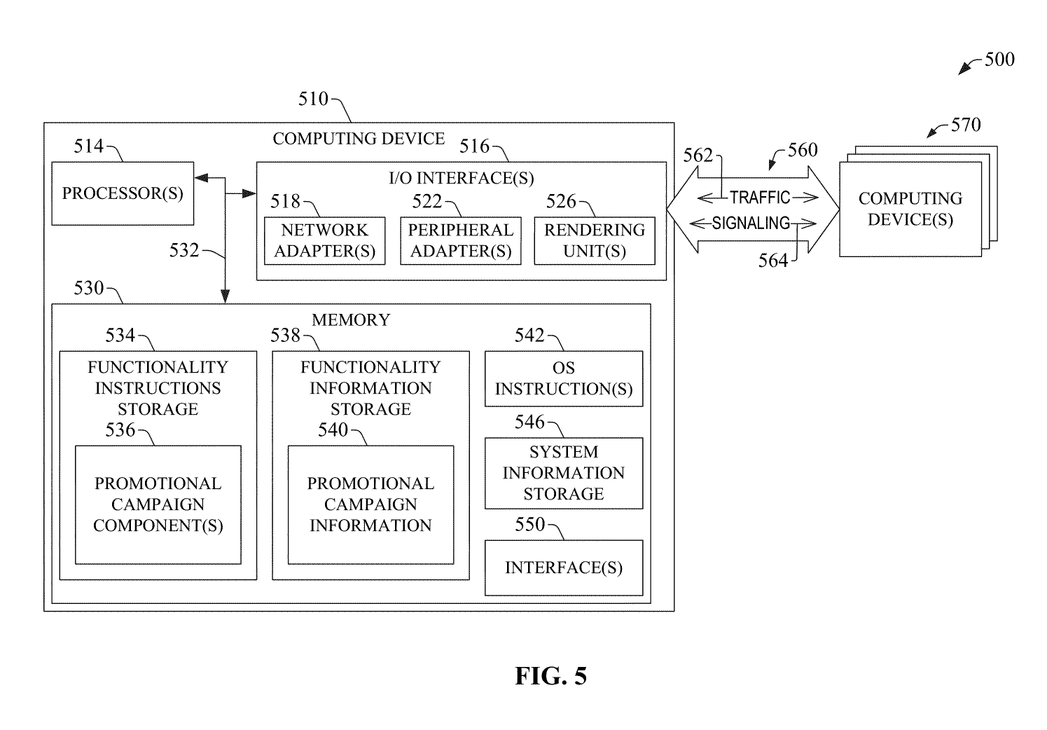

FIG. 5 illustrates a block diagram of an example of a computational environment 500 for generation and management of promotional campaigns in accordance with one or more aspects of the disclosure. The example computational environment 500 is merely illustrative and is not intended to suggest or otherwise convey any limitation as to the scope of use or functionality of the operating environment's architecture. In addition, the illustrative computational environment 500 depicted in FIG. 5 should not be interpreted as having any dependency or requirement relating to any one or combination of components illustrated as part of the computational environment 500. The computational environment 500 comprises a computing device 510 which, in various embodiments, can correspond to one or more units of the campaign management platform 210.

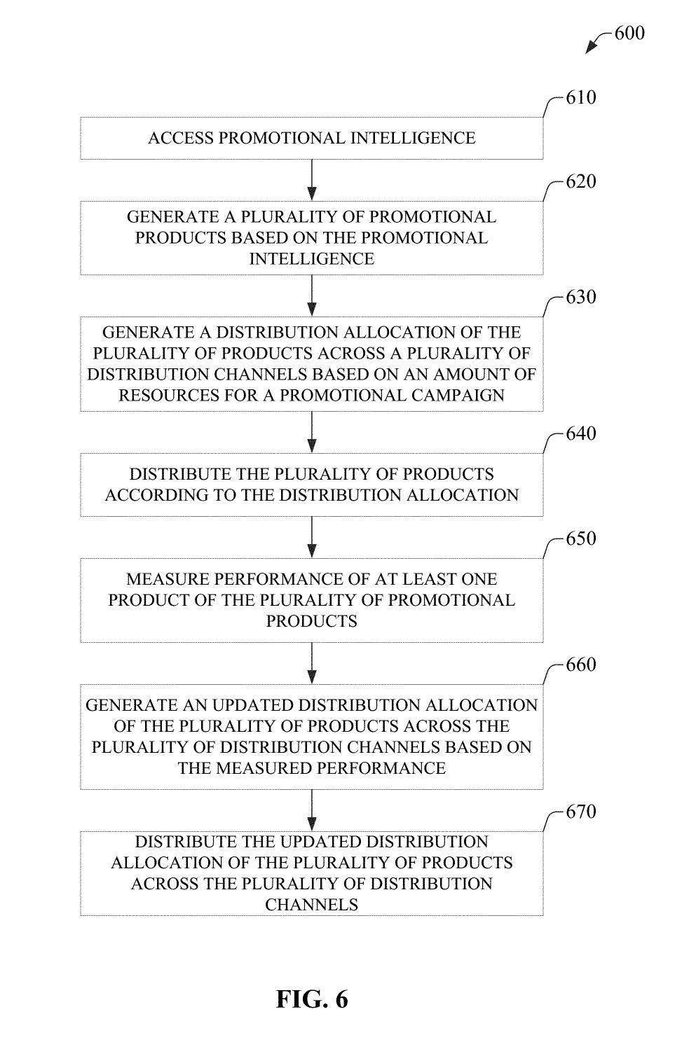

The computational environment 500 represents an example implementation of various aspects of the disclosure in which the processing or execution of operations described in connection with generation and management of promotional campaigns as disclosed herein can be performed in response to execution of one or more software components at the computing device 510. It should be appreciated that the one or more software components can render the computing device 510, or any other computing device that contains such components, a particular machine for generation of promotional campaigns and management thereof as described herein, among other functional purposes. A software component can be embodied in or can comprise one or more computer-accessible instructions, e.g., computer-readable and/or computer-executable instructions. In one scenario, at least a portion of the computer-accessible instructions can embody and/or can be executed to perform at least a part of one or more of the example methods described herein, such as the example method presented in FIG. 6. For instance, to embody one such method, at least a portion of the computer-accessible instructions can be persisted (e.g., stored, made available, or stored and made available) in a computer storage non-transitory medium and executed by a processor. The one or more computer-accessible instructions that embody a software component can be assembled into one or more program modules that can be compiled, linked, and/or executed at the computing device 510 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 510 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects of the disclosure in connection with generation of promotional campaigns and management thereof as described herein can comprise personal computers; server computers; laptop devices; handheld computing devices, such as mobile tablets; wearable computing devices; gesture-based computers; networked or otherwise distributed devices and interfaces; and multiprocessor systems. Additional examples can include set-top boxes, programmable consumer electronics, network PCs, minicomputers, mainframe computers, blade computers, programmable logic controllers (PLCs), distributed computing environments that comprise any of the above systems or devices, or the like.

As illustrated, the computing device 510 can comprise one or more processors 514, one or more input/output (I/O) interfaces 516, one or more memory devices 530 (herein referred to generically as memory 530), and a bus architecture 532 (also termed bus 532) that functionally couples various functional elements of the computing device 510. In certain embodiments, the computing device 510 can include, optionally, a radio unit (not depicted in FIG. 5). The radio unit can include one or more antennas and a communication processing unit that can permit wireless communication between the computing device 510 and another device, such as one of the computing device(s) 570. At least one of the computing device(s) 570 can have similar or identical architecture to the computing device 510. The bus 532 can include at least one of a system bus, a memory bus, an address bus, or a message bus, and can permit exchange of information (data, metadata, and/or signaling) between the processor(s) 514, the I/O interface(s) 516, and/or the memory 530, or respective functional elements therein. In certain scenarios, the bus 532 in conjunction with one or more internal programming interfaces 550 (also referred to as interface(s) 550) can permit such exchange of information. In scenarios in which processor(s) 514 include multiple processors, the computing device 510 can utilize parallel computing.

The I/O interface(s) 516 can permit communication of information between the computing device and an external device, such as another computing device, e.g., a network element or an end-user device. Such communication can include direct communication or indirect communication, such as exchange of information between the computing device 510 and the external device via a network or elements thereof. As illustrated, the I/O interface(s) 516 can comprise one or more of network adapter(s) 518, peripheral adapter(s) 522, and rendering unit(s) 526. Such adapter(s) can permit or facilitate connectivity between the external device and one or more of the processor(s) 514 or the memory 530. For example, the peripheral adapter(s) 522 can include a group of ports, which can comprise at least one of parallel ports, serial ports, Ethernet ports, V.35 ports, or X.21 ports, wherein parallel ports can comprise General Purpose Interface Bus (GPIB), IEEE-1284, while serial ports can include Recommended Standard (RS)-232, V.11, Universal Serial Bus (USB), FireWire or IEEE-1394.

In one aspect, at least one of the network adapter(s) 518 can functionally couple the computing device 510 to one or more computing devices 570 via one or more traffic and signaling pipes 560 that can permit or facilitate exchange of traffic 562 and signaling 564 between the computing device 510 and the one or more computing devices 570. Such network coupling provided at least in part by the at least one of the network adapter(s) 518 can be implemented in a wired environment, a wireless environment, or a combination of both. The information that is communicated by the at least one of the network adapter(s) 518 can result from implementation of one or more operations in a method of the disclosure. Such output can include any form of visual representation, including, but not limited to, textual, graphical, animation, audio, tactile, or the like. In certain scenarios, each of the computing device(s) 570 can have substantially the same architecture as the computing device 510. In addition, or in the alternative, the rendering unit(s) 526 can include functional elements (e.g., lights, such as light-emitting diodes; a display, such as liquid crystal display (LCD), a plasma monitor, a light emitting diode (LED) monitor, an electrochromic monitor; combinations thereof or the like) that can permit control of the operation of the computing device 510, or can permit conveying or revealing the operational conditions of the computing device 510.

In one aspect, the bus 532 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, a Universal Serial Bus (USB) and the like. The bus 532, and all buses described herein can be implemented over a wired or wireless network connection and each of the subsystems, including the processor(s) 514, the memory 530 and memory elements therein, and the I/O interface(s) 516 can be contained within one or more remote computing devices 570 at physically separate locations, connected through buses of this form, thereby effectively implementing a fully distributed system.

The computing device 510 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 510, and can comprise, for example, both volatile and non-volatile media, and removable and/or non-removable media. In one aspect, the memory 530 can comprise computer-readable media in the form of volatile memory, such as random access memory (RAM), and/or non-volatile memory, such as read-only memory (ROM).

The memory 530 can comprise functionality instructions storage 534 and functionality information storage 538. The functionality instructions storage 534 can comprise computer-accessible instructions that, in response to execution by at least one of the processor(s) 514, can implement one or more of the functionalities of the disclosure. The computer-accessible instructions can embody or can comprise one or more software components illustrated as promotional campaign component(s) 536. In one scenario, execution of at least one component of the promotional campaign component(s) 536 can implement one or more of the methods described herein. For instance, such execution can cause a processor that executes the at least one component to carry out a disclosed example method. It should be appreciated that, in one aspect, a processor of the processor(s) 514 that executes at least one of the promotional campaign component(s) 536 can retrieve information from or retain information in a memory element 540 in the functionality information storage 538 in order to operate in accordance with the functionality programmed or otherwise configured by the promotional campaign component(s) 536. Such information can include at least one of code instructions, information structures, or the like. Such instructions and information structures can embody or can constitute machine-learning techniques (e.g., pattern recognition algorithms; inference algorithms; triangulation or location estimation algorithms; temporal algorithms (e.g., algorithms in which an offer is served or otherwise communicated to consumers at a relevant day and/or time); and the like) that can be utilized to implement at least certain functionality described herein. It should be appreciated that, in one example, the relevancy of time to communicate an offer can be determined or otherwise modeled by an inference technique or algorithm. At least one of the one or more interfaces 550 (e.g., application programming interface(s)) can permit or facilitate communication of information between two or more components within the functionality instructions storage 534. The information that is communicated by the at least one interface can result from implementation of one or more operations in a method of the disclosure. In certain embodiments, one or more of the functionality instructions storage 534 and the functionality information storage 538 can be embodied in or can comprise removable/non-removable, and/or volatile/non-volatile computer storage media.

At least a portion of at least one of the promotional campaign component(s) 536 or promotional campaign information 540 can program or otherwise configure one or more of the processors 514 to operate at least in accordance with the functionality described herein. In one embodiment, the promotional campaign component(s) 536 contained in the functionality instruction(s) storage 534 can include one or more of at least one of the interface(s) 212; the exchange unit 218; the composition unit 216; or at least one of the analysis unit(s) 220. It should be recognized that in such an embodiment, hardware or firmware functional elements of the exchange unit 218, the interface(s) 212, the composition unit 216, and/or at least one of the analysis unit(s) 220 can be embodied in suitable components of the computing device 510. For instance, at least one of the processors 514 and at least one of the I/O interface(s) 516 (e.g., a network adapter of the network adapter(s) 518) can embody an interface, (such as GUIs in FIGS. 3A-3C) of the interface(s) 212. One or more of the processor(s) 514 can execute at least one of the promotional campaign component(s) 536 and leverage at least a portion of the information in the functionality information storage 538 in order to provide promotional campaigns and management of same in accordance with one or more aspects described herein.

It should be appreciated that, in certain scenarios, the functionality instruction(s) storage 534 can embody or can comprise a computer-readable non-transitory storage medium having computer-accessible instructions that, in response to execution, cause at least one processor (e.g., one or more of processor(s) 514) to perform a group of operations comprising the operations or blocks disclosed in connection with the methods of this disclosure.

In addition, the memory 530 can comprise computer-accessible instructions and information (e.g., data and/or metadata) that permit or facilitate operation and/or administration (e.g., upgrades, software installation, any other configuration, or the like) of the computing device 510. Accordingly, as illustrated, the memory 530 can comprise a memory element 542 (labeled operating system (OS) instruction(s) 542) that can contain one or more program modules that embody or include one or more operating systems, such as a Windows operating system, Mac OS, Unix, Linux, Symbian, iOS, Android, Chromium, Jolla, Firefox OS, or substantially any OS suitable for mobile computing devices, gesture-based computing devices, connected surfaces and devices, or tethered computing devices. In one aspect, the operational and/or architectural complexity of the computing device 510 can dictate a suitable OS. The memory 530 also comprises a system information storage 546 having data and/or metadata that permits or facilitates operation and/or administration of the computing device 510. Elements of the OS instruction(s) 542 and the system information storage 546 can be accessible or can be operated on by at least one of the processor(s) 514.

It should be recognized that while the functionality instructions storage 534 and other executable program components, such as the OS instruction(s) 542, are illustrated herein as discrete blocks, such software components can reside at various times in different memory components of the computing device 510, and can be executed by at least one of the processor(s) 514. In certain scenarios, an implementation of the promotional campaign component(s) 536 can be retained on or transmitted across some form of computer-readable media.

The computing device 510 and/or one of the computing device(s) 570 can include a power supply (not shown), which can power up components or functional elements within such devices. The power supply can be a rechargeable power supply, e.g., a rechargeable battery, and it can include one or more transformers to achieve a power level suitable for operation of the computing device 510 and/or one of the computing device(s) 570, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 518) to connect operationally to the conventional power grid. In another aspect, the power supply can include an energy conversion component, such as a solar panel, to provide additional or alternative power resources or autonomy for the computing device 510 and/or at least one of the computing device(s) 570.

The computing device 510 can operate in a networked environment by utilizing connections to one or more remote computing devices 570. As an illustration, a remote computing device can be a personal computer, a portable computer, a server, a router, a network computer, a peer device or other common network node, and so on. As described herein, connections (physical and/or logical) between the computing device 510 and a computing device of the one or more remote computing devices 570 can be made via one or more communication platforms 560 (e.g., traffic and signaling pipes), which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

In one or more embodiments, one or more of the disclosed methods can be practiced in distributed computing environments, such as grid-based environments, where tasks can be performed by remote processing devices (computing device(s) 570) that are functionally coupled (e.g., communicatively linked or otherwise coupled) through a network having traffic and signaling pipes and related network elements. In a distributed computing environment, in one aspect, one or more software components (such as program modules) can be located in both the computing device 510 and at least one remote computing device of the computing device(s) 570, for example. It should be appreciated that in such distributed environments, the functionality for generation of organization intelligence and management thereof can be implemented by the system constituted at least by the computing device 510 and at least one of the computing device(s) 570. Such a system can embody or can contain at least a portion of the example operational environment 200 or a portion thereof, e.g., the campaign management platform 210.

In view of the aspects described herein, examples of techniques for promotional campaigns that can be implemented in accordance with at least certain aspects of the disclosure can be better appreciated with reference to the diagram in FIG. 6. For purposes of simplicity of explanation, the examples of the techniques disclosed herein are presented and described as a series of blocks (with each block representing an action or an operation in a method, for example). However, it is to be understood and appreciated that the disclosed techniques (e.g., process(es), procedure(s), method(s), and the like) are not limited by the order of blocks and associated actions or operations, as some blocks may occur in different orders and/or concurrently with other blocks from that are shown and described herein. For example, the various techniques of the disclosure can be alternatively represented as a series of interrelated states or events, such as in a state diagram. Furthermore, not all illustrated blocks, and associated action(s) or operation(s), may be required to implement a technique in accordance with one or more aspects of the disclosure. Further yet, two or more of the disclosed techniques can be implemented in combination with each other, to accomplish one or more features and/or advantages described herein.

It should be appreciated that the techniques of the disclosure can be retained on an article of manufacture, or computer-readable storage medium in order to permit or facilitate transporting and transferring such methods to a computing device (e.g., a desktop computer; a mobile computer, such as a tablet, or a smartphone; gesture-based computers; a connected device or connected surface; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed techniques, can be employed to execute code instructions retained in a memory, or any computer- or machine-readable storage medium, to implement the one or more methods. The code instructions can embody or can constitute the techniques, and thus can provide a computer-executable or machine-executable framework to implement the techniques described herein.

FIG. 6 presents a flowchart of an example of a method 600 for promotional campaigns in accordance with at least certain aspects of the disclosure. In certain embodiments, a system (e.g., a system contained within computational environment 500) having one or more processors coupled (individually or in groups) with one or more memory devices having computer-accessible instructions (e.g., computer-executable and/or computer-readable instructions; also referred to as “instructions”) encoded thereon can implement one or more blocks of the subject example method. At block 610, promotional intelligence can be accessed. As described herein, the promotional intelligence also can be referred to offer intelligence, such as offer intelligence 114. In one example, accessing the promotional intelligence can include receiving one or more of (i) catalog information indicative contemporaneous and/or historical promotional campaigns and related offers for a group of organizations, wherein the information can span a predetermined period; (ii) promotional content associated with one or more of contemporaneous offers or historical offers; (iii) knowledge indicative of practices for issuance of offers according to one or more of season, product category, service category, or organization category; or (iv) satisfactory content for promotional content of an offer or satisfactory type of the offer. While reference is made to a season in connection with the knowledge indicative of practices for issuance of offers, it should be appreciated that other type of factors or information, such other contextual and/or environmental information also can be contemplated regarding such knowledge.

At block 620, a plurality of promotional products can be generated based at least on the promotional intelligence. In one example, generating the one, some, or all of the plurality of promotional products based on the promotional intelligence can include configuring one or more of promotional content or an offer (e.g., a coupon, a deal, a reward, and the like). At block 630, a distribution allocation of one, some, or all of the plurality of products across a plurality of distribution channels can be generated based at least in part on an amount of resources for a promotional campaign. In one example, generating the distribution allocation of the plurality of products across the plurality of distribution channels based on the amount of resources for the promotional campaign comprises assigning a group of products for in a distribution channel based on a portion of the amount of resources. In certain embodiments, the distribution channel can be embodied in a media channel that can pertain to an administrator organization (also referred to as operator organization or operator) that administers the promotional campaign or media channel associated with a third-party partner of the organization. At block 640, the plurality of products can be distributed according to the distribution allocation.

At block 650, the performance of at least one product of the plurality of promotional products can be measured. In one example, measuring the performance of at least one product of the plurality of promotional products can include accessing or otherwise acquiring information indicative of audience activity in response to the at least one product. In addition or in the alternative, measuring the performance of at least one product of the plurality of promotional products further can include generating one or more metrics (such as a key performance indicator) indicative of the audience activity. In one aspect, the audience activity can include one or more actions related to the plurality of promotional products. For example, such activity can include one or more of (i) acquisition of an offer associated with the promotional product; (ii) redistribution of the promotional product (e.g., communication of the promotional product or a portion thereof from one member of the audience to another member of the audience, where the communication is performed via a computing device with wireless and/or wireline communication capability); (iii) redemption of the offer; (iv) initiation of a call session with an organization associated with the at least one promotional product; or (v) completion of a survey or other market research instrument. Other audience activity also is contemplated in accordance with this disclosure.

At block 660, an updated distribution allocation of the plurality of products across the plurality of distribution channels can be generated based at least on the measured performance. At block 670, the updated distribution allocation of the plurality of products can be distributed across the plurality of distribution channels.

Several advantages over conventional technologies for generation and/or management of promotional campaigns emerge from the present specification and annexed drawings. One example advantage may include dynamic restructuring (also referred to as dynamic shaping) of a promotional campaign based on performance of, or responsiveness of an audience to, the promotional campaign and within a specific resource constraint associated with the campaign. Since information indicative of performance of, or responsiveness to, a promotional campaign can be accessed (e.g., collected or otherwise received) automatically as opposed to manually, at least a portion of such information can be accessed in time scales having disparate resolutions spanning various orders of magnitude, including realtime or nearly realtime. Accordingly, in at least certain implementations, the promotional campaign can be restructured nearly continuously or within periods having most any time scale (e.g., milliseconds, seconds, minutes, hours, days, weeks, and the like). Another example advantage may include increased efficacy of a promotional campaigns over time, with the ensuing increased efficiency of utilization of resources (monetary or otherwise) available for promotional campaigns.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “platform,” “architecture,” “interface,” “unit,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “platform,” “architecture,” “interface,” “unit,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer-program products that can provide generation of a promotional campaign and management thereof. It is, of course, not possible to describe every conceivable combination of elements and/or methods for purposes of describing the various features of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A method for promotional campaigns, comprising:
accessing promotional intelligence by a computing system having at least one processor functionally coupled to at least one memory device;
generating, by the computing system, a plurality of promotional products based on the promotional intelligence;
generating, by the computing system, a distribution allocation of the plurality of products across a plurality of distribution channels based on an amount of resources for a promotional campaign;
distributing, by the computing system, the plurality of products according to the distribution allocation;
measuring, by the computing system, performance of at least one product of the plurality of promotional products; and
generating, by the computing system, an updated distribution allocation of the plurality of products across the plurality of distribution channels based on the measured performance.

2. The method of claim 1, further comprising distributing, by the computing system, the updated distribution allocation of the plurality of products across the plurality of distribution channels.

3. The method of claim 1, wherein the accessing comprises receiving one or more of catalog information indicative contemporaneous and historical promotional campaigns and related offers for a group of organizations spanning a predetermined period;
promotional content associated with one or more of contemporaneous offers or historical offers; knowledge indicative of practices for issuance of offers according to one or more of season, product category, service category, or organization category; or satisfactory content for promotional content of an offer or satisfactory type of the offer.

4. The method of claim 1, wherein generating the plurality of promotional products based on the promotional intelligence comprises configuring at least one of promotional content or an offer.

5. The method of claim 1, wherein generating the distribution allocation of the plurality of products across the plurality of distribution channels based on the amount of resources for the promotional campaign comprises assigning a group of products for in a distribution channel based on a portion of the amount of resources,
wherein the distribution channel is a media channel that pertains to an administrator organization that administers the promotional campaign or media channel associated with a third-party partner of the organization.

6. The method of claim 1, wherein measuring the performance of at least one product of the plurality of promotional products comprises accessing information indicative of audience activity in response to the at least one product.

7. The method of claim 6, wherein measuring the performance of at least one product of the plurality of promotional products further comprises generating one or more metrics indicative of the audience activity,
wherein the audience activity comprises one or more of acquisition of an offer associated with the promotional product; redistribution of the promotional product; redemption of the offer; initiation of a call session with an organization associated with the at least one promotional product; or completion of a survey or other market research instrument.

8. A system for promotional campaigns, comprising:
at least one memory device having instructions encoded thereon; and
at least one processor functionally coupled to the at least one memory device and configured, by the instructions,
to access promotional intelligence;
to generate a plurality of promotional products based on the promotional intelligence;
to generate a distribution allocation of the plurality of products across a plurality of distribution channels based on an amount of resources for a promotional campaign;
distribute the plurality of products according to the distribution allocation;
to measure performance of at least one product of the plurality of promotional products; and
to generate an updated distribution allocation of the plurality of products across the plurality of distribution channels based on the measured performance.

9. The system of claim 8, wherein the at least one processor is further configured to distribute the updated distribution allocation of the plurality of products across the plurality of distribution channels.

10. The system of claim 8, wherein the at least one processor is further configured to receive one or more of catalog information indicative contemporaneous and historical promotional campaigns and related offers for a group of organizations spanning a predetermined period; promotional content associated with one or more of contemporaneous offers or historical offers; knowledge indicative of practices for issuance of offers according to one or more of season, product category, service category, or organization category; or satisfactory content for promotional content of an offer or satisfactory type of the offer.

11. The system of claim 8, wherein the at least one processor is further configured to configure at least one of promotional content or an offer.

12. The system of claim 8, wherein the at least one processor is further configured to generate the distribution allocation of the plurality of products across the plurality of distribution channels based on the amount of resources for the promotional campaign comprises assigning a group of products for in a distribution channel based on a portion of the amount of resources,
wherein the distribution channel is a media channel that pertains to an administrator organization that administers the promotional campaign or media channel associated with a third-party partner of the organization.

13. The system of claim 8, wherein the at least one processor is further configured to access information indicative of audience activity in response to the at least one product.

14. The system of claim 13, wherein the at least one processor is further configured to generate one or more metrics indicative of the audience activity,
wherein the audience activity comprises one or more of acquisition of an offer associated with the promotional product; redistribution of the promotional product; redemption of the offer; initiation of a call session with an organization associated with the at least one promotional product; or completion of a survey or other market research instrument.

15. At least one non-transitory storage medium having instructions for promotional campaigns encoded thereon that, in response to execution, cause at least one computing system having at least one processor functionally coupled to at least one memory device to perform operations comprising:
accessing promotional intelligence;
generating a plurality of promotional products based on the promotional intelligence;
generating a distribution allocation of the plurality of products across a plurality of distribution channels based on an amount of resources for a promotional campaign;
distributing the plurality of products according to the distribution allocation;
measuring performance of at least one product of the plurality of promotional products; and
generating an updated distribution allocation of the plurality of products across the plurality of distribution channels based on the measured performance.

16. The at least one non-transitory storage medium of claim 15, wherein the operations further comprise distributing the updated distribution allocation of the plurality of products across the plurality of distribution channels.

17. The at least one non-transitory storage medium of claim 15, wherein the accessing comprises receiving one or more of catalog information indicative contemporaneous and historical promotional campaigns and related offers for a group of organizations spanning a predetermined period; promotional content associated with one or more of contemporaneous offers or historical offers; knowledge indicative of practices for issuance of offers according to one or more of season, product category, service category, or organization category; or satisfactory content for promotional content of an offer or satisfactory type of the offer.

18. The at least one non-transitory storage medium of claim 15, wherein generating the plurality of promotional products based on the promotional intelligence comprises configuring at least one of promotional content or an offer.

19. The at least one non-transitory storage medium of claim 15, wherein generating the distribution allocation of the plurality of products across the plurality of distribution channels based on the amount of resources for the promotional campaign comprises assigning a group of products for in a distribution channel based on a portion of the amount of resources,
wherein the distribution channel is a media channel that pertains to an administrator organization that administers the promotional campaign or media channel associated with a third-party partner of the organization.

20. The at least one non-transitory storage medium of claim 15, wherein measuring the performance of at least one product of the plurality of promotional products comprises accessing information indicative of audience activity in response to the at least one product.

21. The at least one non-transitory storage medium of claim 20, wherein measuring the performance of at least one product of the plurality of promotional products further comprises generating one or more metrics indicative of the audience activity,
wherein the audience activity comprises one or more of acquisition of an offer associated with the promotional product; redistribution of the promotional product; redemption of the offer; initiation of a call session with an organization associated with the at least one promotional product; or completion of a survey or other market research instrument.
